(19) United States
(12) Patent Application Publication
(10) Pub. No.: US 2018/0224403 A1
(43) Pub. Date: Aug. 9, 2018

(54) A New detection method of flavors and fragrances microcapsules release property

(71) Applicant: HUIZHOU RESEARCH INSTITUTE, SUN YAT-SEN UNIVERSITY, Guangdong (CN)

(72) Inventors: Hongbing JI, Guangdong (CN); Fei MA, Guangdong (CN); Weiji LI, Guangdong (CN); Qiong FANG, Guangdong (CN)

(21) Appl. No.: 15/571,513

(22) PCT Filed: Mar. 21, 2017
(86) PCT No.: PCT/CN2017/077414

§ 371 Date: Nov. 3, 2017

(30) Foreign Application Priority Data
Jul. 12, 2016 (CN) 201610555142.3

(51) Int. Cl. G01N 30/06

(52) U.S. Cl. CPC G01N 30/06; G01N 2030/025; G01N 2030/062

(57) ABSTRACT

The invention discloses a method for detecting the release performance of flavors and fragrances microcapsule, comprising the following steps: Using SPME to adsorb the gas sample released by the perfume microcapsules in different time periods under constant temperature and humidity conditions. The SPME adsorption time was 10 s˜30 min and the analytical time in GC/MS was is 1 s˜100 min, and the compounds detected by GC-MS were quantified by area normalization method. The method of the invention is simple and rapid, and is suitable for analyzing and detecting the sustained release of the perfume microcapsules. Using SPME technology, the detection process was without the use of organic solvents and green pollution. The invention can be directly used for the detection of the release of gas components of various perfume microcapsule products without destroying the sample morphology and structure, and more truly reflecting the release performance of the flavors and fragrances microcapsule in real life.

### BACKGROUND OF THE INVENTION

The present invention relates to a novel detection method for the release property of flavors and fragrances microcapsules.

Flavors and fragrances microcapsules is mainly the use of microcapsule technology wrapped spices fragrance, slowing the flavors and fragrances evaporation to achieve controllable and sustained release effect. The detection method had great significance for the release property of the high value-added flavors and fragrances microcapsules, product development and functional research.

The traditional detection of the microcapsule product release effect was evaluated by placing the microcapsule product in a constant temperature and humidity box, by adjusting the different temperature and humidity, and taking the thermal gravimetric analyzer (TG) to examine the release effect of the flavors and fragrances microcapsule and drawn the release curve and calculate the embedding rate.

The current detection methods, are mainly thermal gravimetric analysis and GC-FID quantitative analysis. By measuring the residual mass of the core material in the microcapsules, the encapsulation amount of the microcapsules is calculated, and the release effect of the perfume microcapsules is evaluated indirectly. In real life, spice fragrance microcapsule products are mainly used for skin care products. food and textiles, and other aspects, but people's fragrance microcapsule awareness was mainly through the fragrant substances on the human sensory stimulation reaction. So direct determination of fragrance microcapsules to release the aroma material composition and concentration can be more realistic expression of fragrance microcapsule release effect, and the method compared with the traditional thermal gravimetric detection, with no damage to the outer membrane morphology and structure of the advantages.

Solid phase microextraction (SPME) is a sample pretreatment technique that integrates sampling, enrichment and analysis. The enrichment process requires no solvent and is a green, pollution-free sample pretreatment technology. It has been widely used in environment, food and drugs and so on. The constant temperature and humidity chamber provides favorable conditions for the stable release of microcapsules and is a prerequisite for the determination of microcapsule release performance by TG or GC-FID method.

### BRIEF SUMMARY OF THE INVENTION

In order to reflect the release performance of perfume microcapsules more intuitively and intuitively, the present invention provides a method for detecting the release property of perfume microcapsules, which has the characteristics of simple structure, fast sampling and strong practicability.

In order to achieve the object of the present invention, the technical solution adopted is:

The method for detecting the sustained-release property of a perfume microcapsule comprises the following steps: under the condition of constant temperature and humidity, SPME was used to adsorb the gas samples released from perfume microcapsules in different time periods. The time of SPME adsorption was controlled at 10 s˜100 min. The analytical time of samples in GCME was 1 s˜30 min. The area normalization method and the compounds detected by GC-MS were quantified.

As a preferred embodiment, in the above-described detection method, the SPME coating is one of PDMS, PDMS/DVB, PDMS/DVB/CAR, PA.

As a preferred method, in the above-described detection method, the different time periods are: Day 1, Day 3, Day 5, Day 7, Day 9, Day 17, Day 20, Day 24 And on the 27th day.

As a preferred method, in the above-mentioned detection method, SPME is used to release the gas adsorption sample for perfume microcapsules in different time periods for 1 to 24 hours.

As a preferred method, in the above-described detection method, SPME is used to release gas adsorption samples for perfume fragrance microcapsules under constant temperature conditions for constant temperature and humidity range: temperature 10° C. to 90° C.; humidity 5-95%.

As a preferred embodiment, in the above-described detection method, the conditions of the GC-MS are SHIMADZU GC/MS-QP2010 Plus gas chromatography-mass spectrometer and a Rtx-5MS capillary column (30.0 m×0.25 um×250 mm), and the carrier gas is high purity helium flow rate 3.0 mL/min; program temperature: the initial temperature of 40° C. keeping in 1 min and raising in 10° C./min to 230° C. keeping for 5 min. The split ratio was 50:1 and ion source temperature was 240° C. The ionization mode was EI and scanning mass range 35 m/z-500 m/z.

Compared with the prior art, the invention has the following beneficial effects:

1. The method of the invention is simple and rapid, and is suitable for analyzing and detecting the sustained release gas of perfume microcapsules.

2. The detection process used in the invention does not need to use organic solvent, green pollution.

3. The invention can be directly used for the detection of the gas components of various perfume microcapsules products without destroying the sample morphology and structure, and more truly reflecting the release performance of the flavors and fragrances microcapsules.

### BRIEF DESCRIPTION OF THE DRAWINGS

FIG. 1 shows the total ion chromatogram of the release of the gas component of the lavender essential oil microcapsule;

1-tartin; 2-foliage; 3-linalool; 4-camphor; 5-terpinen-4-ol; 6-acetic acid camphor vinegar; 7-acetic acid lavender vinegar; 8-α-terpilenol

FIG. 2 for the lavender microcapsules at 30° C., 60% humidity sealed for 30 days sustained release effect map;

FIG. 3 for the lavender microcapsules at 30° C., 80% humidity sealed 20 days sustained release effect map;

FIG. 4 for the lavender microcapsules at 30° C., 8% humidity sealed 20 days sustained release effect map;

FIG. 5 for the detection flow chart.

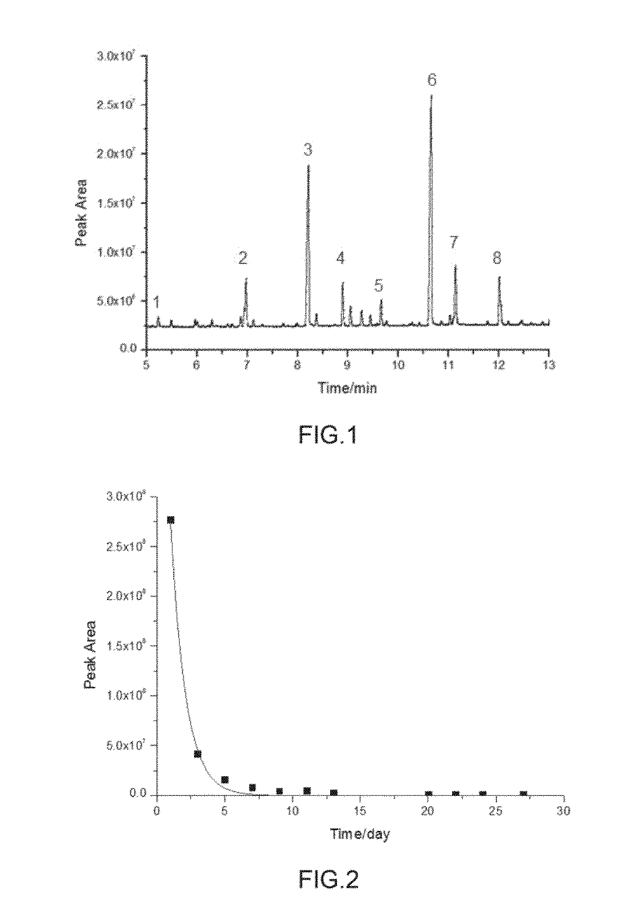

### DETAILED DESCRIPTION OF THE INVENTION

The present invention will be further described with reference to the following examples, but the scope of protection of the present method is not limited to the scope of the embodiments.

### Example 1

Lavender essential oil microcapsules were tested in release performance. 0.010 g of lavender essential oil microcapsule samples were placed in a 20.0 mL headspace bottle. On the first day, GC-MS was analyzed by CAR-DVB-PDMS (50/30) coated SPME for 1 hour after the release of gas for 1 h at a constant temperature of 30° C. and a humidity of 60%

Day 2, constant temperature and humidity box was emptied the bottle and opened vent, place time 1 day.

On the third day, the gas s extracted with CAR/DVB/PDMS (50/30) and take 1 h for GC-MS analysis.

Day 4 emptied bottle and opened vent in constant temperature and humidity box, place fort day.

Day 5, the gas was extracted with CAR/DVB/PDMS (50/30) coated SPME for 1 h, and analyzed by GC-MS.

And so on, the 6 days, 7 days, 8 days . . . to 27 days.

GC-MS test conditions are all the same: the conditions of the GC-MS are SHIMADZU GC/MS-QP2010 Plus gas chromatography-mass spectrometer and a Rtx-5MS capillary column (30.0 m×0.25 0.25 um×250 mm), and the carrier gas is high purity helium flow rate 3.0 mL/min; program temperature: the initial temperature of 40° C. keeping in 1 min and raising in 10° C./min to 230° C. keeping for 5 min. The split ratio was 50:1 and ion source temperature was 240° C. The ionization mode was EI and scanning mass range 35 m/z-500 m/z.

Slow release effect as shown in FIG. 2, the daily slow release volume decreases with time, the data fitting analysis, the microcapsule sustained release model in line with the release model, the fitting curve: Y=exp(−0.9037x+20.3419), R2=0.99681

### Example 2

Lavender essential oil microcapsules were tested in a sustained-release performance, and 0.010 g of lavender essential oil microcapsule samples were placed in a 20.0 mL headspace bottle. On the first day, the cells were allowed to stand for 24 hours at a constant temperature of 30° C. and a humidity of 80%. After 24 days, the gas was extracted with CAR/DVB/PDMS (50/30) GC-MS analysis.

Day 3, emptied bottle and opened vent in constant temperature and humidity box, place for 1 day.

Day 4, the gas was extracted with CAR/DVB/PDMS (50/30) coating SPME on the release of gas and take 1 h for GC-MS analysis.

Day 5, constant temperature and humidity box top empty bottle open vent, place time 2 days.

Day 7, the gas was extracted with CAR-DVB-PDMS (50/30) coating SPME on the gas and take 1 h for GC-MS analysis.

And so on, the first 8 days, 9 days, 11 days . . . to the 19th day. GC-MS test conditions are all the same: the conditions of the GC-MS are SHIMADZU GC/MS-QP2010 Plus gas chromatography-mass spectrometer and a Rtx-5MS capillary column (30.0 m×0.25 um×250 mm), and the, carrier gas is high purity helium flow rate 3.0 mL/min; program temperature: the initial temperature of 40° C. keeping in 1 min and raising in 10° C./min to 230° C. keeping for 5 min. The split ratio was 50:1 and ion source temperature was 240° C. The ionization mode was EI and scanning mass range 35 m/z-500 m/z.

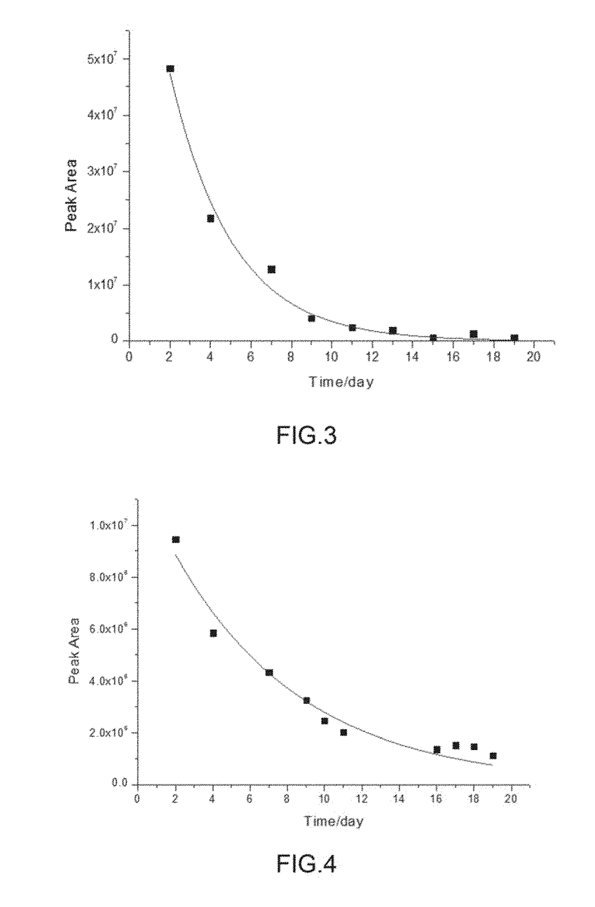

Slow release effect diagram shown in FIG. 3, the daily slow release volume decreases with time, the data fitting analysis, the microcapsule sustained release model in line with the first release model the curve is: Y=exp (−3255x+18.3259), R2=0.98683

### Example 3

Lavender essential oil microcapsules were tested in a sustained-release performance, and 0.010 g of lavender essential oil microcapsule samples were placed in a 20.0 mL headspace bottle. On the first day, the cells were sealed with a CAR/DVB/PDMS (50/30) coating SPME for 1 h. and the gas was extracted for 1 h after release for 47 h at a constant temperature of 30° C. and a constant humidity of 80%-MS analysis.

On the third day, the top empty bottle in the constant temperature and humidity chamber was ventilated and placed for 47 hours. The gas was extracted with CAR/DVB/PDMS (50/30) coating SPME for 1 h, and GC-MS analysis.

Day 5, constant temperature and humidity box top empty bottle open vent, place the time 71 h after sealing the top empty bottle. GC/MS analysis was carried out using CAR/DVB/PDMS (50/30) coated SPME for 1 h after the release of the gas.

Days 7, constant temperature and humidity box top empty bottle open vent, place the time after 23 h sealed the top empty bottle. GC/MS analysis was carried out using CAR/DVB/PDMS (50/30) coated SPME for 1 h after the release of the gas.

Day 8, constant temperature and humidity box top empty bottle open vent, place the time after 23 h sealed top empty bottle. GC/MS analysis was carried out using CAR/DVB/PDMS (50/30) coated SPME for 1 h after the release of the gas.

And so on, the first 9 days, 10 days, 11 days . . . to the 19th day.

GC-MS test conditions are all the same: the conditions of the GC-MS are SHIMADZU GC/MS-QP2010 Plus gas chromatography-mass spectrometer and a Rtx-5MS capillary column (30.0 m×0.25 um×250 mm), and the carrier gas is high purity helium flow rate 3.0 mL/min; program temperature: the initial temperature of 40° C. keeping in 1 min and raising in 10° C./min to 230° C. keeping for 5 min. The split ratio was 50:1 and ion source temperature was 240° C. The ionization mode was, EI and scanning mass range 35 m/z-500 m/z.

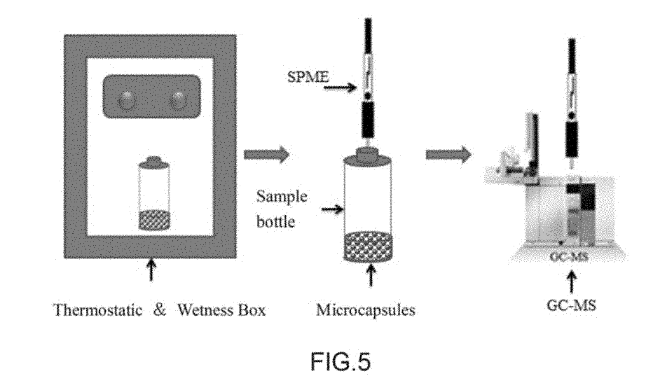

Sustained release effect diagram shown in FIG. 4, the instantaneous release of microcapsules with the amount of time to reduce the length of the data. The results showed that the sustained—release model of microcapsules was in accordance with the first—order release model. The fitting curve was Y=exp(−0.2069x+17.0337) and R2=0.94444.

What is claimed is:

1. The invention relates to a method for detecting the release property of a perfume fragrance microcapsule, which comprises the following steps: Using SPME to adsorb the gas sample released by the perfume microcapsules in different time periods under constant temperature and humidity conditions. The SPME adsorption time was 10 s˜30 min and the analytical time in GC/MS was 1 s˜100 min, and the compounds detected by GC-MS were quantified by area normalization method.

2. The detection method according to claim 1, the SPME coating is one of PDMS, PDMS/DVB, PDMS/DVB/CAR and PA.

3. The detection method according to claim 1, the different time periods are the 1st, 3rd, 5th, 7th, 9th, 17th, 20th, 24th, 27th in a month.

4. The detection method according to claim 1, the adsorption time for the gas sample for the perfume microcapsules in different time periods by SPME is 1 to 24 hours.

5. The detection method according to claim 1, the gas is adsorbed by SPME under constant temperature condition for different time periods, and the constant temperature and humidity range is: temperature 10° C. to 90° C. and humidity 5˜95%.

6. The detection method according to claim 1, the conditions of the GC-MS are SHIMADZU GC/MS-QP2010 Plus gas chromatography-mass spectrometer and a Rtx-5MS capillary column (30.0 m×0.25 um×250 mm), and the carrier gas is high purity helium flow rate 3.0 mL/min; program temperature: the initial temperature of 40° C. keeping in 1 min and raising ire 10° C./min to 230° C. keeping for 5 min. The split ratio was 50:1 and ion source temperature was 240° C. The ionization mode was EI and scanning mass range 35 m/z-500 m/z.
